(19) United States
(12) Patent Application Publication
(10) Pub. No.: US 2024/0079180 A1
(43) Pub. Date: Mar. 7, 2024

(54) RARE EARTH PERMANENT MAGNET, AND PREPARATION METHOD THEREFOR

(71) Applicants: YANTAI ZHENGHAI MAGNETIC MATERIAL CO., LTD., Yantai, Shandong (CN); JIANGHUA ZHENGHAI MINMETALS ADVANCED MATERIALS CO., LTD., Yongzhou, Hunan (CN)

(72) Inventors: Zhiqiang LI, Yantai, Shandong (CN); Cong WANG, Yantai, Shandong (CN); Pengfei WANG, Yantai, Shandong (CN); Rui WEI, Yantai, Shandong (CN)

(21) Appl. No.: 18/260,088

(22) PCT Filed: Dec. 29, 2021
(86) PCT No.: PCT/CN2021/142528

§ 371 Date: Jun. 30, 2023

(30) Foreign Application Priority Data
Dec. 30, 2020 (CN) 202011628718.7

(51) Int. Cl. H01F 41/02; B22F 3/16; B22F 3/24; B22F 9/02; B22F 9/04; C22C 38/00; C22C 38/06; C22C 38/10; C22C 38/14; C22C 38/16; H01F 1/057

(52) U.S. Cl. CPC H01F 41/0273; B22F 3/16; B22F 3/24; B22F 9/023; B22F 9/04; C22C 38/002; C22C 38/005; C22C 38/06; C22C 38/10; C22C 38/14; C22C 38/16; H01F 1/0577; H01F 41/0266; H01F 41/0293; B22F 2003/242; B22F 2003/248; B22F 2201/20; B22F 2202/05; B22F 2301/355; B22F 2998/10; B22F 2999/00; C22C 2202/02

(57) ABSTRACT

A rare earth permanent magnet, and a preparation method therefor are provided. The rare earth permanent magnet M and the preparation method may effectively improve the grain boundary anisotropy of the magnet, provide more diffusion channels through which a heavy rare earth diffusion source can enter the inside of the magnet, such that the heavy rare earth diffusion source is more effectively diffused into the magnet, the intrinsic coercivity of the magnet is greatly improved, and a magnet N having high intrinsic coercivity is obtained. Using the same amount of a heavy rare earth diffusion source material, the method produces magnet N having high intrinsic coercivity amplification with reduced production costs.

The present application claims priority to the prior application with the application No. 202011628718.7 and entitled “RARE EARTH PERMANENT MAGNET, AND PREPARATION METHOD THEREFOR” filed with China National Intellectual Property Administration by the applicant on Dec. 30, 2020, which is incorporated herein by reference in its entirety.

### TECHNICAL FIELD

The present disclosure belongs to the technical field of preparation of rare earth permanent magnets, and relates to a rare earth permanent magnet and a preparation method therefor.

### BACKGROUND

At present, there is an increasing use of sintered neodymium-iron-boron rare earth permanent magnets in the field of new energy. Both the use range and the consumption are increasing year by year. Considering that the intrinsic coercivity Hcj of the neodymium-iron-boron rare earth permanent magnet is significantly reduced at a high temperature, thereby causing irreversible thermal demagnetization, it needs to improve the intrinsic coercivity level of the neodymium-iron-boron rare earth permanent magnet so as to meet use requirements of the magnet at a high temperature. In this regard, the grain boundary diffusion process of heavy rare earth has been widely used in recent years. In this process, through a heat treatment process at a certain temperature for a certain period of time, a heavy rare earth diffusion source coated on the outside of the magnet diffuses into the magnet along a liquid grain boundary phase at a high temperature, and heavy rare earth elements are mainly distributed along the grain boundary or an outer shell layer of main phase grains and do not explicitly enter a core of main phase grains. Therefore, an effect of significantly improving the coercivity of the magnet on the premise of hardly reducing remanence of the magnet can be realized.

The increase amplitude of coercivity of the rare earth permanent magnet subjected to the diffusion process of heavy rare earth is significantly higher than that of the rare earth permanent magnet added with the heavy rare earth elements in the same proportion in a smelting formulation. Therefore, there is a need to seek a method for more effectively improving the increase amplitude of diffusion coercivity, which has great significance for effectively improving the performance of the magnet and reducing product costs.

Patent reference 1 (CN104159685A) discloses a method for sandblasting an outer periphery of a quenching roller, which can remove deposits on the outer peripheral surface of the quenching roller to suppress a decrease in a cooling rate, thereby reducing a variance in a crystal structure to improve uniformity in the crystal structure.

Patent reference 2 (CN105261473A) discloses that a surface of a copper roller is subjected to sandblasting and polishing to reduce damaged area of the surface of the copper roller, thereby prolonging the service life, and a strip cast slice obtained by cooling of the copper roller subjected to sandblasting and polishing is cooled uniformly and has a more uniform distribution of internal columnar crystals and neodymium-rich phases.

Patent reference 3 (CN1306527C) discloses a method for improving uniformity in distribution of a rare earth-rich phase in grain boundary, which comprises adjusting the surface roughness, as represented by 10-point average roughness (Rz), of a quenching roller to fall within a range of 5 to 100 μm, so that a region of fine rare earth-rich phase of alloy slices is reduced by volume, thereby improving uniformity in the rare earth-rich phase of the slices.

Patent reference 4 (JP09001296A) discloses a method for adjusting surface roughness of an abrasion-resistant metal layer of a quenching roller, wherein surface roughness Ra1 of a central part on an outer peripheral surface of the roll made of the abrasion-resistant metal layer is adjusted to be greater than surface roughness Ra2 of two sides on the outer peripheral surface, enabling improving the uniformity in the crystal structure, thereby improving the remanence and the intrinsic coercivity of the magnet.

Non-patent reference 5 (Acta Materialia, 2016, 112:59-66) investigated anisotropy of a diffusion process, and a heavy rare earth-enriched shell structure is more likely to form at an interface parallel to the [001] direction (c-axis direction) of main phase grains.

In all of the patent references 1 to 4, the surface state of the quenching roller is adjusted to improve the uniformity in the structure of the sintered magnet, thereby achieving the purpose of improving the performance of the sintered magnet. However, any of the patent documents does not refer to what method is used to prepare a sintered rare earth permanent magnet having anisotropic distribution of the grain boundary which is more suitable for the grain boundary diffusion of the heavy rare earth and having improvement in coercivity to a greater extent, and how to make content distribution of the heavy rare earth diffused in the magnet more reasonable.

The non-patent reference 5 studies difference in diffusion anisotropy due to lattice anisotropy of a main phase of Re₂Fe₁₄B, but similarly does not refer to influence of the anisotropy of the grain boundary on diffusion.

Considering the significant difference in diffusion speed of the heavy rare earth elements in the magnets with different distribution characteristics of grain boundary structure, if the traditional process is adopted, even if the uniformity in the grain boundary structure is significantly improved, the anisotropic distribution of the grain boundary is relatively poor, and then, even if the magnet is subjected to the diffusion process of the heavy rare earth, it is still difficult for the heavy rare earth elements to effectively enter into the magnet, and though there is an increase in the coercivity of the magnet, the increase amplitude tends to be relatively low.

If it is possible to effectively optimize anisotropic distribution of a grain boundary structure, realize improvement in increase amplitude of coercivity of a magnet during diffusion, reduce the content of heavy rare earth of the magnet, and reduce the production cost of the magnet, it has become an urgent technical problem to be solved.

### SUMMARY

The present disclosure provides a rare earth permanent magnet, denoted as a rare earth permanent magnet M, which is obtained by oriented-pressing molding in a magnetic field and sintering; dimensions of the magnet in a direction perpendicular to both a pressing direction and an orientation direction of the magnetic field after the pressing and after the sintering are denoted as a1 and a2, respectively;
dimensions of the magnet in the pressing direction after the pressing and after the sintering are denoted as b1 and b2, respectively;
dimensions of the magnet in the orientation direction of the magnetic field after the pressing and after the sintering are denoted as c1 and c2, respectively;
the dimensions of the rare earth permanent magnet M satisfy formula (1):

c2/c1≤1.25×b2/b1+1.1×a2/a1−1.26 (1);

and/or,
a structure anisotropy coefficient of the rare earth permanent magnet M is defined as A=(105×c2/c1)/(a2/a1+b2/b1), satisfying formula (2):

A≤44.5 (2).

According to an embodiment of the present disclosure, c2/c1≤0.75, such as c2/c1≤0.74, preferably 0.65<c2/c1≤0.73, and as an example, c2/c1=0.697, 0.699, 0.701, 0.706, 0.712, or 0.724.

According to an embodiment of the present disclosure, b2/b1 ranges from 0.80 to 0.95, such as from 0.83 to 0.92, and as an example, b2/b1=0.86, 0.862, 0.863, 0.864, 0.87, 0.88, or 0.888.

According to an embodiment of the present disclosure, a2/a1 ranges from 0.75 to 0.90, such as from 0.805 to 0.84, and as an example, a2/a1=0.807, 0.808, 0.811, 0.813, 0.815, 0.82, 0.83, or 0.839.

According to an embodiment of the present disclosure, A may be in a range of 40≤A≤44.2, for example, A may be 43, 43.5, 43.59, 43.82, 43.94, 44.02, or 44.1.

According to an embodiment of the present disclosure, an oxygen content in the rare earth permanent magnet M is below 1500 ppm, for example, below 1000 ppm, more preferably, below 800 ppm. For the rare earth permanent magnet M, the low oxygen content means that a generation amount of the rare earth-rich oxide enriched in a region of grain boundary at triple point is low, which is beneficial for improving diffusion speed of a heavy rare earth diffusion source in a grain boundary phase and improving performance of a diffusion magnet (namely, the rare earth permanent magnet N in the following).

According to an embodiment of the present disclosure, during the oriented-pressing molding, an intensity of the magnetic field is ≥1.5 T so as to ensure that the magnetic field orientation of the magnet during the pressing molding reaches a saturation state at which point the grain boundary phase deflects along with the main phase grains and is intensively distributed in a plane parallel to the orientation, which is more conducive to the diffusion of the heavy rare earth into the magnet.

The rare earth permanent magnet M satisfying the formulas (1) and/or (2) has more significant anisotropic distribution of the grain boundary phases within the magnet, that is, more grain boundary phases are distributed in the plane parallel to the orientation direction to serve as diffusion channels during the heavy rare earth diffusion, so that the heavy rare earth diffusion source can be more diffused into the magnet along the diffusion channels on the premise of the same usage amount, thereby effectively improving the increase amplitude of coercivity before and after the diffusion in the magnet, and increasing the intrinsic coercivity of the magnet after the diffusion (namely the rare earth permanent magnet N in the following).

The present disclosure further provides a rare earth permanent magnet, denoted as a rare earth permanent magnet N, wherein an average content of heavy rare earth of the rare earth permanent magnet N from the surface of the magnet to a position at 0.08-0.12 mm (preferably 0.1 mm) away from the surface inside the magnet along an orientation direction of a magnetic field is denoted as x (wt %), an average content of heavy rare earth from the surface of the magnet to a position at 0.98-1.02 mm (preferably 1 mm) away from the surface inside the magnet along the orientation direction of the magnetic field is denoted as y (wt %), and an overall thickness of the rare earth permanent magnet N is denoted as z;
wherein when z≤6,

x−y≤1.3\hat{ }(z+0.5)+0.3 (3);
when z>6,

x−y≤5.5+z/13 (4);
the overall thickness refers to a thickness of the magnet along the orientation direction of the magnetic field; and
preferably, the rare earth permanent magnet N is obtained by diffusing the heavy rare earth diffusion source into the rare earth permanent magnet M.

According to an embodiment of the present disclosure, when z≤6, x−y≤6, and as an example, x−y=0.3, 1.4, 2.5, or 3.4.

According to an embodiment of the present disclosure, when z>6, x−y≤8, and as an example, x−y=2.4, 4.5, or 6.2.

The organizational structure of the grain boundary of the rare earth permanent magnet M satisfying the formulas described above is more conducive to the entry of the heavy rare earth diffusion source into the magnet during diffusion. In the case of the same weight of the diffusion source used, the content of the heavy rare earth existing on the surface of the magnet is decreased, and the content of the heavy rare earth entering into the magnet is increased. Therefore, the difference in the contents of the heavy rare earth from the surface of the magnet to a position at 0.1 mm and a position at 1 mm away from the surface inside the magnet along the orientation direction of the magnetic field becomes smaller, which effectively improves the increase amplitude and the consistency of the coercivity of the magnet before and after the diffusion, and increases the intrinsic coercivity of the diffusion magnet (namely the rare earth permanent magnet N).

According to an embodiment of the present disclosure, an oxygen content in the rare earth permanent magnet N is below 1500 ppm, for example, below 1000 ppm, more preferably, below 800 ppm. The heavy rare earth diffusion source on the surface of the rare earth permanent magnet M with low oxygen content enters more into the magnet, thus the difference in the concentration of the heavy rare earth between the interior and exterior of the magnet is further decreased, thereby improving the increase amplitude of intrinsic coercivity of the rare earth permanent magnet N obtained by diffusing into the magnet.

The present disclosure provides a preparation method for the rare earth permanent magnet M described above, comprising the following steps:
(1) supplying an alloy melt comprising a raw material for preparing the rare earth permanent magnet M to a quenching roller, and solidifying the alloy melt to obtain alloy slices, wherein surface roughnesses Ra and Rz of an outer peripheral surface of the quenching roller satisfy that: Ra is in the range of 0.5 to 15 μm and Rz is in the range of 0.5 to 45 μm; and
(2) subjecting the alloy slices obtained in the step (1) to pulverizing, oriented-pressing molding, and sintering to obtain the rare earth permanent magnet M.

According to an embodiment of the present disclosure, the raw material for preparing the rare earth permanent magnet M is a raw material known in the art.

For example, the raw material for preparing the rare earth permanent magnet M comprises elements R, Fe, and B, wherein R is one, two or more of Nd, Pr, Ce, Ho, Dy, and Tb, and accounts for 25%-35% by weight of the raw material; and B accounts for 0.8%-1.5% by weight of the raw material; the raw material further comprises an additive element which is one, two or more of Co, Ti, Ga, Cu, Al, and Zr, and accounts for 0.5%-5% by weight of the raw material; and the balance is Fe. Preferably, by weight percentage, the raw material for preparing the rare earth permanent magnet M comprises PrNd in an amount of 19%-35%, Dy in an amount of 0%-6%, Co in an amount of 0.3%-4%, Cu in an amount of 0.01%-0.4%, Ga in an amount of 0.01%-0.5%, Al in an amount of 0.01%-1.2%, Zr in an amount of 0.01%-0.2%, Ti in an amount of 0.01%-0.3%, and B in an amount of 0.8%-1.2%, with the balance being Fe.

The sum of the contents of Co, Cu, Ga, Al, Zr, and Ti is in the range of 0.5% to 5% by weight of the raw material described above.

As an example, by weight percentage, the raw material for preparing the rare earth permanent magnet M comprises PrNd in an amount of 27%, Dy in an amount of 4%, Co in an amount of 2%, Cu in an amount of 0.1%, Ga in an amount of 0.1%, Al in an amount of 0.4%, Zr in an amount of 0.1%, and B in an amount of 1%, with the balance being Fe.

According to an embodiment of the present disclosure, in the step (1), the surface of the quenching roller may be treated by shot blasting, shot peening, sandblasting, sandpapering, or the like, so that the surface roughnesses Ra and Rz of the outer peripheral surface of the quenching roller satisfy the requirements described above.

According to an embodiment of the present disclosure, in the step (1), the surface roughness Ra of the outer peripheral surface of the quenching roller is in the range of 1 to 12 μm, for example, 3 μm, 4 μm, 4.5 μm, 5 μm, or 10 μm.

According to an embodiment of the present disclosure, in the step (1), the surface roughness Rz of the outer peripheral surface of the quenching roller is in the range of 3 to 30 μm, such as in the range of 3 to 25 μm, for example, 7 μm, 7.3 μm, 7.9 μm, 8 μm, 10 μm, 10.6 μm, 12 μm, 13 μm, 15 μm, 20 μm, or 25 μm.

According to an embodiment of the present disclosure, in the step (1), the alloy slices have an average thickness of 0.15 to 0.5 μm, such as 0.2 to 0.4 μm, and as an example, 0.15 μm, 0.2 μm, 0.3 μm, 0.4 μm, or 0.5 μm.

According to an embodiment of the present disclosure, step (2) comprises: performing a hydrogenation on the alloy slices to obtain a coarse powder; adding an antioxidant and a lubricant to the coarse powder to prepare a mixed powder; subjecting the mixed powder to oriented-pressing molding to obtain a compact; and subjecting the compact to sintering to obtain the rare earth permanent magnet M,
wherein the antioxidant and the lubricant may be selected from agents known in the art; further, the total amount of the antioxidant and the lubricant is 3 to 6 wt %, such as 4 to 5.5 wt %, and as an example, 5 wt % or 5.5 wt %, of the raw material for preparing the rare earth permanent magnet M;
the hydrogenation is performed at a pressure of 0.1 to 0.4 MPa, such as 0.15 to 0.3 MPa, and as an example, 0.2 MPa;
the hydrogenation is performed for 3 to 6 h, such as 4 to 5 h, and as an example, 3 h, 4 h, 4.5 h, 5 h, or 6 h;
the hydrogenation is performed at a temperature of 500 to 660° C., such as 530 to 600° C., and as an example, at a temperature of 550° C.;
the coarse powder can be prepared by an air flow mill; for example, the coarse powder has a surface mean diameter (SMD, also known as Sauter mean diameter) of 2 to 4 μm, such as 2.5 to 3.5 μm, and as an example, 2.8 μm; and
during the oriented-pressing, an intensity of a magnetic field is ≥1.5 T; for example, the intensity of the magnetic field is ≥2 T, and as an example, 2 T. The intensity of the magnetic field ensures that the magnetic field orientation of the magnet during the pressing molding reaches a saturation state at which point the grain boundary phase deflects along with the main phase grains and is intensively distributed in a plane parallel to the orientation direction, which is more conducive to the diffusion of the heavy rare earth into the magnet.

The skilled person in the art can select a pressing method, such as isostatic pressing, according to requirements. Further, the isostatic pressing is performed at a pressure of 160 to 180 MPa, such as 165 to 175 MPa, and as an example, 170 MPa.

The sintering is vacuum sintering, for example, performed in a vacuum heat treatment furnace. Preferably, before the sintering by heating, a vacuum degree in the furnace reaches 10⁻² Pa, and an oxygen content in the furnace is lower than 100 ppm.

The sintering is vacuum sintering aging. Preferably, the sintering is performed at a temperature of 1000 to 1150° C., such as 1030 to 1100° C., and as an example, 1070° C. Preferably, the primary aging is performed at a temperature of 800 to 950° C., such as 850 to 930° C., and as an example, 900° C. Preferably, the secondary aging is performed at a temperature of 470 to 550° C., such as 500 to 540° C., and as an example, 520° C.

The present disclosure further provides use of the rare earth permanent magnet M described above in the preparation of a rare earth permanent magnet with a high increase amplitude of intrinsic coercivity.

Preferably, the rare earth permanent magnet with the high increase amplitude of intrinsic coercivity is the rare earth permanent magnet N described above.

Preferably, the increase amplitude of intrinsic coercivity is at least 10 kOe, such as 10.2 to 15 kOe.

The present disclosure further provides a preparation method for the rare earth permanent magnet N described above, comprising the following steps:
(a) disposing a heavy rare earth diffusion source to a surface of the rare earth permanent magnet M; and
(b) upon completion of step (a), performing a heat treatment on the magnet with a heavy rare earth on the surface to obtain the rare earth permanent magnet N.

According to an embodiment of the present disclosure, in the step (a), the heavy rare earth diffusion source comprises at least one of pure metals Tb, Dy, and alloys of Tb and/or Dy with other metals, preferably Tb and/or Dy.

According to an embodiment of the present disclosure, in the step (a), the heavy rare earth diffusion source may be disposed to the surface of the rare earth permanent magnet M by using a method known in the art, such as thermal spraying, vacuum evaporation, coating, magnetron sputtering, burying, immersion, and the like.

According to an embodiment of the present disclosure, in the step (b), the heat treatment may comprise a two-stage heat treatment process. For example, the first-stage heat treatment is performed at a temperature of 800 to 1000° C., such as 850 to 950° C., and as an example, 900° C. For example, the first-stage heat treatment is performed with a holding time of at least 3 h, such as 3 to 35 h, preferably 5 to 30 h, and as an example, 10 h, 20 h, or 30 h. For example, the second-stage heat treatment is performed at a temperature of 400 to 650° C., such as 450 to 600° C., and as an example, 400° C., 500° C., or 600° C. For example, the second-stage heat treatment is performed with a holding time of 1 to 10 h, such as 2 to 8 h, and as an example, 3 h, 5 h, or 7 h.

The advantageous effects of the present disclosure are as follows:

The inventors have made extensive studies to solve the above problems, and found that the rare earth permanent magnet having the characteristics of the magnet M described in the present disclosure has a significantly improved increase amplitude of coercivity by diffusing heavy rare earth as compared with that of a general permanent magnet. In addition, in the preparation of the magnet M, since the alloy slices are prepared by a treatment method using a quenching roller, it is necessary to control the surface roughness Ra of the outer peripheral surface of the quenching roller to be in the range of 0.5 to 15 μm and the surface roughness Rz to be in the range of 0.5 to 45 μm, so as to improve the increase amplitude of intrinsic coercivity after diffusion.

The rare earth permanent magnet M and the preparation method therefor provided by the present disclosure can effectively improve the anisotropy of the grain boundary of the magnet to provide more diffusion channels through which the heavy rare earth diffusion source enters into the magnet, thereby enabling the heavy rare earth diffusion source to more effectively diffuse into the magnet to improve the intrinsic coercivity of the magnet more substantially, thus obtaining a magnet N with the high intrinsic coercivity.

Compared with the prior art, the present disclosure can obtain the magnet N with the higher increase amplitude of intrinsic coercivity in the case of the same usage amount of the heavy rare earth diffusion source, reducing the production cost of the magnet.

### DETAILED DESCRIPTION

A R-T-B system sintered magnet has typical anisotropy in term of its electrical resistivity, thermal expansion coefficient and the like, besides magnetic characteristics. The inventors found out through experiments that: there is a significant difference in the increase amplitude of intrinsic coercivity in different directions of the magnet during diffusion of heavy rare earth, and the increase amplitude of intrinsic coercivity of the magnet after the diffusion along a c-axis direction in which the grain boundary phase is most enriched is the highest, that is, the diffusion process of the heavy rare earth diffusion source also has significant anisotropy. Therefore, the present disclosure provides a magnet with more internal diffusion channels (namely the rare earth permanent magnet M) by taking an optimal direction in the diffusion anisotropy as a target, so that more heavy rare earth diffusion sources can enter into the magnet through more diffusion channels, thereby reducing difference in the concentration of the heavy rare earth between a surface layer and a subsurface layer of the magnet to further improve the increase amplitude of coercivity of the heavy rare earth-diffused product.

Regarding the anisotropy of the grain boundary structure, it is difficult to be characterized by directly measuring a specific parameter. In the present disclosure, a change rate c2/c1 from the dimension of the magnet in each direction after oriented-pressing in a magnetic field to the dimension after sintering is mainly used as a measurement standard for the anisotropic distribution of the grain boundary. The anisotropy of the grain boundary structure directly affects dimension shrinkage of the magnet in the orientation direction, the pressing direction, and the third direction perpendicular to the orientation direction and the pressing direction during sintering. This is mostly because: the grain boundary phase is intensively distributed among columnar crystals parallel to the c-axis in the strip cast alloy slices after smelting, and during hydrogen absorption (hydrogen decrepitation), the columnar crystal structure is broken into a plurality of polyhedrons along the c-axis direction, the grain boundary phase among the columnar crystals during smelting is reserved on a plane parallel to the c-axis which has more distribution of grain boundary phases, while the section vertical to the c-axis rarely has grain boundary phases. The anisotropic distribution characteristics of the grain boundary phases is enhanced during oriented-pressing, which is finally reflected in the significant anisotropy of shrinkage in the orientation direction, the pressing direction, and the third direction perpendicular to the orientation direction and the pressing direction during the sintering.

In addition, through extensive experiments, the present inventors have found that, in the preparation of the magnet M, since the alloy slices are produced by a treatment method using a quenching roller, it is necessary to control the surface roughness Ra of the outer peripheral surface of the quenching roller to be in the range of 0.5 to 15 μm and the surface roughness Rz to be in the range of 0.5 to 45 μm, which is effective in increasing the structure anisotropy of the grain boundary phases of the alloy slices, increasing the number of grain boundary phases in a plane parallel to the orientation direction and decreasing the number of grain boundary phases in a plane perpendicular to the orientation direction. Due to inheritance of structure, the improvement in the distribution anisotropy of grain boundary is transferred to the sintered magnet, ultimately resulting in a significant improvement in the increase amplitude of diffusion coercivity of the diffusion magnet (namely the magnet N).

This structure anisotropy actually does not significantly improve the magnetic properties of the sintered magnet (namely the magnet M). It is possibly because the total amount of grain boundary phases is not increased, and the grain boundary phases increased in the plane parallel to the orientation direction are actually from the grain boundary phases in the plane perpendicular to the orientation direction, so that the enhancement of magnetic insulating action between the grains in the parallel plane and the weakening of magnetic insulating action in the perpendicular plane are superimposed on each other, ultimately resulting in the inability to effectively improve the coercivity level of the sintered magnet. Unexpectedly, the magnet with strong anisotropic distribution of grain boundary has significant advantages during diffusion of heavy rare earth. For the heavy rare earth diffusion source, it is easier to diffuse towards the magnet along the orientation direction, so as to reduce difference in the content of the heavy rare earth between the surface layer and the subsurface layer of the magnet, improving the increase amplitude of coercivity during diffusing the heavy rare earth into the magnet.

For the permanent magnet M prepared by the present disclosure, the ratio of the dimension after sintering to the dimension after pressing in the orientation direction satisfies that c2/c1≥1.25×b2/b1+1.1×a2/a1−1.26. If c2/c1 is too large, the grain boundary phases of the magnet in the plane parallel to the orientation direction are decreased, affecting the improvement of the diffusion coercivity. The anisotropy coefficient A (A=(105×c2/c1)/(a2/a1+b2/b1)) of the permanent magnet M satisfies that A≤44.5. If the A is too large, the grain boundary tends to be distributed around grains more isotropically, so as to reduce the diffusion speed of the heavy rare earth diffusion source.

For the permanent magnet N prepared by the present disclosure, the content of the heavy rare earth from the surface of the magnet to a position at 0.08-0.12 mm away from the surface inside the magnet along the orientation direction of the magnetic field is x (wt %), the content of the heavy rare earth from the surface of the magnet to a position at 0.98-1.02 mm away from the surface inside the magnet along the orientation direction of the magnetic field is y (wt %), and they have the following relationship with the overall thickness of the rare earth permanent magnet N:
when z≤6,

x−y≤1.3\hat{ }(z+0.5)+0.3;and
when z>6,

x−y≤5.5+z/13.

If x−y is too large, the heavy rare earth is excessively and intensively distributed on the surface of the magnet while an amount of heavy rare earth diffusing to the center is insufficient, thereby affecting the intrinsic coercivity of the magnet.

The magnet after diffusion is processed into a standard sample block of 10×10 mm for testing. The magnetic properties is measured on a NIM-62000 apparatus, and X-ray fluorescence spectroscopy (XRF) is used to measure the content x of the heavy rare earth from the surface of the magnet to a position at 0.08-0.12 mm away from the surface inside the permanent magnet along the orientation direction of the magnetic field (taking 5 measurement points in total at four corners and at center, taking an average of the contents of the heavy rare earth at the 5 points) and the content y of the heavy rare earth from the surface of the magnet to a position at 0.98-1.02 mm away from the surface inside the magnet along the orientation direction of the magnetic field (taking 5 measurement points in total at four corners and at center, taking an average of the contents of the heavy rare earth at the 5 points).

The technical scheme of the present disclosure will be further illustrated in detail with reference to the following specific examples. It will be appreciated that the following embodiments are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the raw materials and reagents used in the following examples are all commercially available products or can be prepared using known methods.

### Example 1

The following raw materials for sintered neodymium-iron-boron permanent magnets by weight percentage were prepared: 27% of PrNd, 4% of Dy, 2% of Co, 0.1% of Cu, 0.1% of Ga, 0.4% of Al, 0.1% of Zr, and 1% of B, with the balance being Fe. Alloy slices were prepared by using the raw materials described above through a rapid hardening and strip casting method, wherein a surface of a quenching roller in a strip casting furnace was treated by sandblasting to control a surface roughness Ra of the outer peripheral surface of the quenching roller to be 5 μm, and a surface roughness Rz to be 13 μm.

The obtained rapid hardened alloy slices were subjected to hydrogenation with a hydrogen absorption pressure of 0.2 MPa and a dehydrogenation temperature of 550° C., and then subjected to air flow milling to obtain a powder with an SMD of 2.8 μm. A lubricant accounting for 0.05 wt % of the raw materials was added, and then the mixed materials were mixed in a mixer for 1 h and subjected to air flow milling to obtain a powder. A lubricant and an antioxidant totally accounting for 0.5 wt % of the raw materials were added to the obtained powder and then mixed for another 3 h. The homogeneously mixed fine alloy powder was subjected to oriented-pressing in a magnetic field at a controlled intensity of the orientation field of 2 T, and then subjected to isostatic pressing at 170 MPa.

The compact was placed in a vacuum heat treatment furnace with a controlled vacuum degree below 20 Pa, an oxygen content below 300 ppm, a sintering temperature of 1065° C., a primary tempering temperature of 900° C., and a secondary tempering temperature of 520° C.

The sintered blank was machined to 10-10-2 mm, in which the dimension along the orientation direction of the magnetic field was 2 mm, which was denoted as a rare earth permanent magnet M1. By means of magnetron sputtering, the heavy rare earth terbium (Tb) was disposed to the surface of the magnet M1, and then subjected to heat treatment. In the heat treatment process, the first-stage heat treatment was performed at a diffusion temperature of 900° C. with a holding time of 30 h, followed by the second-stage heat treatment at 500° C. with a holding time of 10 h. A rare earth permanent magnet N1 was obtained. The performance of the magnet N1 was examined.

### Example 2

The following raw materials for sintered neodymium-iron-boron permanent magnets by weight percentage were prepared: 27% of PrNd, 4% of Dy, 2% of Co, 0.1% of Cu, 0.1% of Ga, 0.4% of Al, 0.1% of Zr, and 1% of B, with the balance being Fe. Alloy slices were prepared by using the raw materials described above through a rapid hardening and strip casting method, wherein a surface of a quenching roller in a strip casting furnace was treated by shot peening to control a surface roughness Ra of the outer peripheral surface of the quenching roller to be 4.5 μm, and a surface roughness Rz to be 10.6 μm.

The obtained rapid hardened alloy slices were subjected to hydrogenation with a hydrogen absorption pressure of 0.2 MPa and a dehydrogenation temperature of 550° C., and then subjected to air flow milling to obtain a powder with an SMD of 2.8 μm. A lubricant accounting for 0.05 wt % of the raw materials was added, and then the mixed materials were mixed in a mixer for 1 h and subjected to air flow milling to obtain a powder. A lubricant and an antioxidant totally accounting for 0.5 wt % of the raw materials were added to the obtained powder and then mixed for another 3 h. The homogeneously mixed fine alloy powder was subjected to oriented-pressing in a magnetic field at a controlled intensity of the orientation field of 2 T, and then subjected to isostatic pressing at 170 MPa.

The compact was placed in a vacuum heat treatment furnace with a controlled vacuum degree below 20 Pa, an oxygen content below 300 ppm, a sintering temperature of 1065° C., a primary tempering temperature of 900° C., and a secondary tempering temperature of 520° C.

The sintered blank was machined to 10-10-2 mm, in which the dimension along the orientation direction was 2 mm, which was denoted as a rare earth permanent magnet M2.

By means of evaporation, the heavy rare earth terbium (Tb) was disposed to the surface of the magnet M2, and then subjected to heat treatment. In the heat treatment process, the first-stage heat treatment was performed at a diffusion temperature of 900° C. with a holding time of 30 h, followed by the second-stage heat treatment at 500° C. with a holding time of 10 h. A rare earth permanent magnet N2 was obtained. The performance of the magnet N2 was examined.

### Example 3

The following raw materials for sintered neodymium-iron-boron permanent magnets by weight percentage were prepared: 27% of PrNd, 4% of Dy, 2% of Co, 0.1% of Cu, 0.1% of Ga, 0.4% of Al, 0.1% of Zr, and 1% of B, with the balance being Fe. Alloy slices were prepared by using the raw materials described above through a rapid hardening and strip casting method, wherein a surface of a quenching roller in a strip casting furnace was treated by shot blasting to control a surface roughness Ra of the outer peripheral surface of the quenching roller to be 3 μm, and a surface roughness Rz to be 7.3 μm.

The obtained rapid hardened alloy slices were subjected to a hydrogenation with a hydrogen absorption pressure of 0.2 MPa and a dehydrogenation temperature of 550° C., and then subjected to air flow milling to obtain a powder with an SMD of 2.8 μm. A lubricant accounting for 0.05 wt % of the raw materials was added, and then the mixed materials were mixed in a mixer for 1 h and subjected to air flow milling to obtain a powder. A lubricant and an antioxidant totally accounting for 0.5 wt % of the raw materials were added to the obtained powder and then mixed for another 3 h. The homogeneously mixed fine alloy powder was subjected to oriented-pressing in a magnetic field at a controlled intensity of the orientation field of 2 T, and then subjected to isostatic pressing at 170 MPa.

The compact was placed in a vacuum heat treatment furnace with a controlled vacuum degree below 20 Pa, an oxygen content below 300 ppm, a sintering temperature of 1065° C., a primary tempering temperature of 900° C., and a secondary tempering temperature of 520° C.

The sintered blank was machined to 10-10-6 mm, in which the dimension along the orientation direction was 6 mm, which was denoted as a rare earth permanent magnet M3.

By means of coating, the heavy rare earth terbium (Tb) was disposed to the surface of the magnet M3, and then subjected to heat treatment. In the heat treatment process, the first-stage heat treatment was performed at a diffusion temperature of 900° C. with a holding time of 30 h, followed by the second-stage heat treatment at 500° C. with a holding time of 10 h. A rare earth permanent magnet N3 was obtained. The performance of the magnet N3 was examined.

### Example 4

The following raw materials for sintered neodymium-iron-boron permanent magnets by weight percentage were prepared: 27% of PrNd, 4% of Dy, 2% of Co, 0.1% of Cu, 0.1% of Ga, 0.4% of Al, 0.1% of Zr, and 1% of B, with the balance being Fe. Alloy slices were prepared by using the raw materials described above through a rapid hardening and strip casting method, wherein a surface of a quenching roller in a strip casting furnace was treated by shot peening to control a surface roughness Ra of the outer peripheral surface of the quenching roller to be 3 μm, and a surface roughness Rz to be 7.9 μm.

The obtained rapid hardened alloy slices were subjected to a hydrogenation with a hydrogen absorption pressure of 0.2 MPa and a dehydrogenation temperature of 550° C., and then subjected to air flow milling to obtain a powder with an SMD of 2.8 μm. A lubricant accounting for 0.05 wt % of the raw materials was added, and then the mixed materials were mixed in a mixer for 1 h and subjected to air flow milling to obtain a powder. A lubricant and an antioxidant totally accounting for 0.5 wt % of the raw materials were added to the obtained powder and then mixed for another 3 h.

The homogeneously mixed fine alloy powder was subjected to oriented-pressing in a magnetic field at a controlled intensity of the orientation field of 2 T, and then subjected to isostatic pressing at 170 MPa.

The compact was placed in a vacuum heat treatment furnace with a controlled vacuum degree below 20 Pa, an oxygen content below 300 ppm, a sintering temperature of 1065° C., a primary tempering temperature of 900° C., and a secondary tempering temperature of 520° C.

The sintered blank was machined to 10-10-6 mm, in which the dimension along the orientation direction was 6 mm, which was denoted as a rare earth permanent magnet M4.

By means of thermal spraying, the heavy rare earth terbium (Tb) was disposed to the surface of the magnet M4, and then subjected to heat treatment. In the heat treatment process, the first-stage heat treatment was performed at a diffusion temperature of 900° C. with a holding time of 30 h, followed by the second-stage heat treatment at 500° C. with a holding time of 10 h. A rare earth permanent magnet N4 was obtained. The performance of the magnet N4 was examined.

### Comparative Example 1

In this comparative example, the surface roughness Ra of the outer peripheral surface of the quenching roller was controlled to be 5 μm, and the surface roughness Rz was controlled to be 16 μm.

The remaining preparation steps were the same as in Example 1.

### Comparative Example 2

In this comparative example, the surface roughness Ra of the outer peripheral surface of the quenching roller was controlled to be 12 μm, and the surface roughness Rz was controlled to be 54 μm.

The remaining preparation steps were the same as in Example 1.

### Comparative Example 3

In this comparative example, the surface roughness Ra of the outer peripheral surface of the quenching roller was controlled to be 17 jam, the surface roughness Rz was controlled to be 63 jam, and the proportion of the heavy rare earth as a diffusion material used during diffusion was half of that in the examples.

The remaining preparation steps were the same as in Example 2.

Table 1 shows the roughness of the quenching rollers, the dimensions of the pressed blanks and the sintered blanks in three directions, and the anisotropy coefficient A of the magnets M obtained in the examples and comparative examples.

TABLE 1

| | Ra | Rz | a1 | a2 | b1 | b2 | c1 | c2 | | |
|---|---|---|---|---|---|---|---|---|---|---|
| | (μm) | (μm) | (mm) | (mm) | (mm) | (mm) | (mm) | (mm) | c2/c1 | A |
| Example 1 | 5 | 32 | 30.00 | 24.39 | 40.00 | 34.48 | 50.00 | 35.05 | 0.701 | 43.94 |
| Example 2 | 4.1 | 21 | 30.00 | 24.36 | 40.00 | 34.52 | 50.00 | 34.95 | 0.699 | 43.82 |
| Example 3 | 3.1 | 13 | 30.00 | 24.45 | 40.00 | 34.56 | 50.00 | 34.85 | 0.697 | 43.59 |
| Example 4 | 3.3 | 18 | 30.00 | 25.17 | 40.00 | 35.52 | 50.00 | 36.20 | 0.724 | 44.02 |
| Comparative | 7 | 52 | 30.00 | 24.87 | 40.00 | 34.92 | 50.00 | 36.20 | 0.724 | 44.66 |
| Example 1 | | | | | | | | | | |
| Comparative | 12 | 90 | 30.00 | 24.21 | 40.00 | 34.24 | 50.00 | 35.70 | 0.714 | 45.08 |
| Example 2 | | | | | | | | | | |
| Comparative | 17 | 122 | 30.00 | 24.03 | 40.00 | 34.04 | 50.00 | 35.30 | 0.706 | 44.87 |
| Example 3 | | | | | | | | | | |

Table 2 shows the concentrations of heavy rare earth in the surface layers and the subsurface layers along the diffusion directions, the evaluation of whether formula (1) is satisfied, the evaluation of whether formula (2) is satisfied, the evaluation of whether formula (3) is satisfied, Br after diffusion, Hcj after diffusion, and an increase amplitude of Hcj during diffusion for the magnets N obtained in Examples 1-4 and Comparative Examples 1-3.

TABLE 2

| | | | | | | Whether | | | | |
|---|---|---|---|---|---|---|---|---|---|---|
| | Whether | Whether | | | | formula 3 | Br after | Hcj before | Hcj after | |
| | formula 1 | formula 2 | x | y | z | or formula 4 | diffusion | diffusion | diffusion | ΔHcj |
| | is satisfied | is satisfied | (wt %) | (wt %) | (mm) | is satisfied | (kGs) | (kOe) | (kOe) | (kOe) |
| Example 1 | Yes | Yes | 1.67 | 0.27 | 2 | Yes | 13.05 | 23.34 | 36.51 | 13.17 |
| Example 2 | Yes | Yes | 1.45 | 0.30 | 2 | Yes | 13.02 | 23.46 | 36.67 | 13.21 |
| Example 3 | Yes | Yes | 2.45 | 0.28 | 6 | Yes | 13.06 | 23.18 | 35.94 | 12.76 |
| Example 4 | Yes | Yes | 3.01 | 0.33 | 6 | Yes | 13.01 | 23.05 | 35.77 | 12.72 |
| Comparative | Yes | No | 2.67 | 0.20 | 2 | No | 13.00 | 23.41 | 35.07 | 11.66 |
| Example 1 | | | | | | | | | | |
| Comparative | No | No | 3.48 | 0.20 | 2 | No | 13.07 | 23.62 | 34.19 | 10.57 |
| Example 2 | | | | | | | | | | |
| Comparative | No | No | 1.03 | 0.17 | 2 | Yes | 13.05 | 23.37 | 31.40 | 8.03 |
| Example 3 | | | | | | | | | | |

In summary, from Tables 1 and 2, it can be seen that: the surface roughnesses Ra and Rz of the outer peripheral surface of the quenching roller were controlled to obtain a magnet having stronger anisotropy distribution characteristics of grain boundary, but it does not mean that, the anisotropic distribution characteristics of grain boundary are stronger so long as the shrinkage ratio of c2/c1 in the direction of orientation c is lower. For example, in Example 4, the ratio of c2/c1 is the highest among the examples, but the shrinkage ratios of a2/a1 and b2/b1 relative to the directions a and b are lower, so that a magnet with stronger anisotropic distribution characteristics of grain boundary, which also has the same advantage in the increase amplitude of coercivity after diffusion, can also be prepared.

The ranges of the surface roughness Ra and the surface roughness Rz of the outer peripheral surface of the quenching roller were controlled. Through the testing data of Comparative Example 1 and Comparative Example 2, it can be concluded that, when the formula (1) is satisfied, the anisotropy of the grain boundary has been enhanced so that the heavy rare earth can enter into the magnet more effectively along the grain boundary, improving the increase amplitude of coercivity of the magnet before and after diffusion.

Through the testing data of Example 1 and Comparative Example 1, it can be concluded that: when the change in the dimensions of the magnets before and after pressing satisfies the formula (1) and the anisotropy coefficient A also satisfies the formula (2), more heavy rare earth diffusion sources can enter into the magnet through more diffusion channels along the axis-c direction in which the grain boundary phases are most enriched, so as to reduce the difference in the concentration of heavy rare earth between the surface layer and the subsurface layer of the magnet, thereby further improving the increase amplitude of coercivity of heavy rare earth-diffused product. Therefore, the ΔHcj of the rare earth permanent magnet has a greater improvement than that of those magnets which do not satisfy the formulas (1) and (2).

Through the testing data of Example 2 and Comparative Example 3, it can be concluded that: although the difference in the concentration of heavy rare earth between the surface layer and the subsurface layer can be effectively reduced by reducing the proportion of heavy rare earth used during diffusion so that the formula (3) can be satisfied, the increase amplitude of coercivity before and after diffusion is far less than the normal level, so the practical application effect is relatively poor. In summary, the rare earth permanent magnet prepared by the present disclosure has a greater shrinkage in the orientation direction relative to the other two directions and thus more significant anisotropy of the grain boundary, with more heavy rare earth diffusion sources entering into the magnet after diffusion, so that the rare earth permanent magnet has a significantly improved increase amplitude of intrinsic coercivity.

The examples of the present disclosure have been described above. However, the present disclosure is not limited to the examples described above. Any modification, equivalent, improvement and the like made without departing from the spirit and principle of the present disclosure shall fall within the protection scope of the present disclosure.

1. A rare earth permanent magnet, wherein the rare earth permanent magnet denoted as a rare earth permanent magnet M is obtained by oriented-pressing molding and sintering in a magnetic field; wherein:
dimensions of the magnet in a direction perpendicular to both a pressing direction and an orientation direction of the magnetic field after the pressing and after the sintering are denoted as a1 and a2, respectively;
dimensions of the magnet in the pressing direction after the pressing and after the sintering are denoted as b1 and b2, respectively;
dimensions of the magnet in the orientation direction of the magnetic field after the pressing and after the sintering are denoted as c1 and c2, respectively;
the dimensions of the rare earth permanent magnet M satisfy the following formula:
c2/c11.25×b2/b1+1.1×a2/a1−1.26 (1);
and/or,
a structure anisotropy coefficient of the rare earth permanent magnet N is defined as A=(105×c2/c1)/(a2/a1+b2/b1), satisfying the following formula:
A≤44.5 (2).

2. The rare earth permanent magnet according to claim 1, wherein c2/c1≤0.75;
preferably, b2/b1 ranges from 0.80 to 0.95;
preferably, a2/a1 ranges from 0.75 to 0.90; and
preferably, an oxygen content in the rare earth permanent magnet M is below 1500 ppm.

3. A rare earth permanent magnet, wherein the rare earth permanent magnet is denoted as a rare earth permanent magnet N, an average content of heavy rare earth of the rare earth permanent magnet N from a surface of the magnet to a position at 0.08-0.12 mm away from the surface inside the magnet along an orientation direction of a magnetic field is denoted as x, an average content of heavy rare earth from the surface of the magnet to a position at 0.98-1.02 mm away from the surface inside the magnet along the orientation direction of the magnetic field is denoted as y, and an overall thickness of the rare earth permanent magnet N is denoted as z;
wherein:
when z≤6, x−y≤1.3\hat{ }(z+0.5)+0.3 (3); and
when z>6, x−y≤5.5+z/13 (4).

4. The rare earth permanent magnet according to claim 3, wherein the rare earth permanent magnet N is obtained by treating a rare earth permanent magnet M with a heavy rare earth diffusion source;
preferably, when z≤6, x−y≤6;
preferably, when z>6, x−y≤8; and
preferably, an oxygen content of the rare earth permanent magnet N is below 1500 ppm.

5. A preparation method for the rare earth permanent magnet M according to claim 1, wherein the method comprises the following steps:
(1) supplying an alloy melt comprising a raw material for preparing the rare earth permanent magnet M to a quenching roller, and solidifying the alloy melt to obtain alloy slices,
wherein surface roughnesses Ra and Rz of an outer peripheral surface of the quenching roller satisfy that: Ra is in the range of 0.5 to 15 μm and Rz is in the range of 0.5 to 45 μm; and
(2) subjecting the alloy slices obtained in the step (1) to pulverizing, oriented-pressing molding, and sintering to obtain the rare earth permanent magnet M.

6. The preparation method according to claim 5, wherein in the step (1), a surface of the quenching roller is treated by shot blasting, shot peening, sandblasting, or sandpapering;
preferably, in the step (1), the surface roughness Ra of the outer peripheral surface of the quenching roller is in the range of 1 to 12 μm;
preferably, in the step (1), the surface roughness Rz of the outer peripheral surface of the quenching roller is in the range of 3 to 30 μm; and
preferably, in the step (1), the alloy slices have an average thickness of 0.15 to 0.5 μm.

7. The preparation method according to claim 5, wherein the step (2) comprises: performing hydrogenation on the alloy slices to obtain a coarse powder;
adding an antioxidant and a lubricant to the coarse powder to prepare a mixed powder;
subjecting the mixed powder to oriented-pressing molding to obtain a compact; and subjecting the compact to sintering to obtain the rare earth permanent magnet M;
preferably, during the oriented-pressing molding, an intensity of the magnetic field is ≥1.5 T;
preferably, the oriented-pressing molding is isostatic pressing molding;
preferably, the sintering is vacuum sintering, preferably performed in a vacuum heat treatment furnace; and preferably, before the sintering by heating, a vacuum degree in the furnace reaches 10⁻² Pa, and an oxygen content in the furnace is lower than 100 ppm.

8. Use of the rare earth permanent magnet M according to claim 1 in the preparation of a rare earth permanent magnet with a high increase amplitude of intrinsic coercivity, wherein
preferably, the rare earth permanent magnet with the high increase amplitude of intrinsic coercivity is the rare earth permanent magnet N;
preferably, the increase amplitude of intrinsic coercivity is at least 10 kOe; and
preferably, the increase amplitude of intrinsic coercivity is at least 12 kOe.

9. A preparation method for the rare earth permanent magnet N according to claim 3, wherein the preparation method comprises the following steps:
(a) disposing a heavy rare earth diffusion source to a surface of the rare earth permanent magnet M; and
(b) upon completion of step (a), performing a heat treatment on the magnet with a heavy rare earth on its surface to obtain the rare earth permanent magnet N.

10. The preparation method according to claim 9, wherein in the step (a), the heavy rare earth diffusion source comprises at least one of pure metals Tb, Dy, and alloys of Tb and/or Dy with other metals, preferably Tb and/or Dy;
preferably, in the step (a), the heavy rare earth diffusion source is disposed to the surface of the rare earth permanent magnet M by thermal spraying, vacuum evaporation, coating, magnetron sputtering, or burying; and
preferably, in the step (b), the heat treatment comprises a two-stage heat treatment process.
